(19) United States
(12) Patent Application Publication
(10) Pub. No.: US 2005/0240380 A1
(43) Pub. Date: Oct. 27, 2005

(54) Reducing context memory requirements in a multi-tasking system

(76) Inventor: Kenneth Dale Jones, Atkinson, NH (US)

Correspondence Address: TEXAS INSTRUMENTS INCORPORATED, P O BOX 655474, M/S 3999, DALLAS, TX, 75265, US

(21) Appl. No.: 10/813,130

(22) Filed: Mar. 31, 2004

(51) Int. Cl. G06F 17/50

(52) U.S. Cl. 703/1

(57) ABSTRACT

A process for reducing the context memory requirements in a processing system is provided by a generic, lossless, compression algorithm applied to multiple tasks or multiple instances running on any type of processor. The process includes dividing data in a task of a multi-tasking system into blocks with each block containing the same number of words. For the data in each task, a word in a block having a maximum number of significant bits is determined, a packing width to the block of said maximum number of significant bits is assigned, and the least significant bits of each word in the block into a packed block of the packing width multiplied by a total number of words in the block is encoded with a lossless compression algorithm. A prefix header at the beginning of each packed block to represent a change in the packing width from the packed block from a packing width of a previous packed block is also provided.

### CROSS-REFERENCE TO RELATED APPLICATIONS

None

### FIELD OF THE INVENTION

The present invention relates generally to reducing the context memory requirements in a multi-tasking system, and more specifically applying a generic, lossless, compression algorithm to multiple tasks running on any type of processor.

### BACKGROUND OF THE INVENTION

Computer processors that execute multiple software functions (e.g., multi-tasking) using only on-chip memory must be able to operate the functions in a limited memory environment while conforming to size constraints of the chip and cost-effectiveness of manufacturing. While multitasking, a processor is simultaneously running numerous tasks that consume memory. Each task requires a certain amount of memory to hold each task's variables that are unique to itself. A problem with limited memory environments on processors is that all the memory is contained on the chip: the software operating on the chip does not use external memory. If more memory is added, the chip requires a larger footprint and becomes more costly to manufacture. For example, in a voice-data channel context, a barrier to increasing the number of channels per chip, and therefore reducing the power per channel and cost per channel, is the amount of on-chip memory that can be incorporated into a given die size. The die size is determined by yield factors and that establishes a memory-size limit.

Some methods of memory management use algorithms to compress and decompress code as the code executes. However, this method does not compress variables or constants and uses software instructions instead of a faster system using a hardware engine. What is desirable, then is a system for reducing the amount of context memory used by a software system running multiple tasks or multiple instances on a processor that has a fixed memory size.

### SUMMARY

The problems of the prior art are overcome in the preferred embodiment by applying a generic, lossless compression algorithm to each task in a multitasking environment on a processor to reduce the context memory requirement of each task. The algorithm of the present invention operates as an adaptive packing operation. This method applies to any software system running on any type of processor and is useful for applications which process a large number of tasks and where each task consumes a significant amount of context memory.

### BRIEF DESCRIPTION OF THE DRAWINGS

Preferred embodiments of the invention are discussed hereinafter in reference to the drawings, in which:

FIG. 1 illustrates a series of data blocks containing word samples;

FIG. 2 is a graphical illustration of channel context memory contents for a typical voice over IP application;

FIG. 3 is a functional illustration of memory flow used by the preferred embodiment;

FIG. 4 illustrates a functional diagram of an exemplary hardware encoder;

FIG. 5 illustrates a functional diagram of an exemplary hardware decoder;

FIG. 6 illustrates channel context memory contents for a typical voice over IP application together with a measure of compression obtained in each region of memory.

### DETAILED DESCRIPTION OF PREFERRED EMBODIMENTS

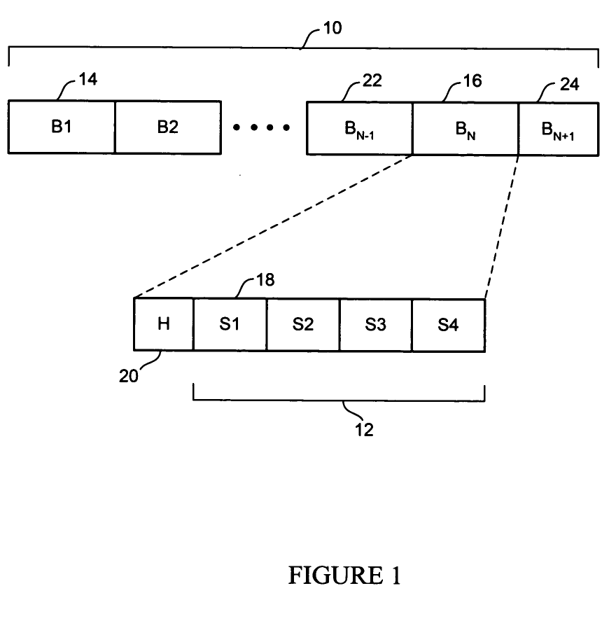

The preferred and alternative exemplary embodiments of the present invention include a channel-context compression algorithm that operates through a hardware engine in a processor having 16-bit data words. However, the algorithm will operate effectively for processors using 32-bit or other sizes of data words. The exemplary encoder is an adaptive packing operation. Referring to FIG. 1, input to the encoder is divided into blocks 10 of four 16-bit words 12 illustrated as samples S1 through S4. The blocks 10 may contain any reasonable number of words as samples, such as six, eight, or ten words. These words 12 are treated as twos-complement integers. Each block 14 is examined to find the word with the maximum number of significant bits. This number of significant bits is called the packing width and each word in the block can be represented with this number of bits. For example, if the word S₁ (18) has the largest magnitude in block (16) of −100, then block B_{N} 16 is assigned a packing width P_{N}=8 bits for each of the words S₁ through S₄. The P_{N} least significant bits of the four words S₁ through S₄ (12) in block B_{N} (16) are then packed into a block of 4*P_{N} bits. There is no loss of information in this packing operation.

FIG. 1 also shows a prefix header H 20 that is added to the beginning of the packed block 16 to represent the change in packing width from the previous block B_{N-1} (22). In the example this change is defined as P_{N}-P_{N-1}. This difference is encoded as a variable-length sequence using between one and seven bits. The packing size for each block B₁ to B_{N+1} must be known in order to determine how to unpack each block. Representing the difference in packing size between blocks 10 occupies fewer bits in a processor memory as compared to using a set number of bits each time, for example four bits for the change in size between each block B₁ through B_{N+1}.

To form the prefix header 20, the packing width difference is computed modulo sixteen and then encoded as follows: 0 is encoded as the single bit 0; 1 or 15 are encoded as the 3 bits 11×, where X=1 for 1 and X=0 for 15; 2 and 14 are encoded as the 4 bits 101×, where X=1 for 2 and X=0 for 14; 3 through 13 are encoded as the 7 bits 100XXXX where XXXX directly gives the numbers 3 through 13. The codes 100XXXX where XXXX represents 0-2 or 14-15 are not valid codes; however, the 6-bit code 100000 is used as a last block marker.

The compressed output consists of the prefix header 20 followed by the packed block 12. These bits are packed into 16 bit words, from most significant bit to least significant bit. When a word is full, packing continues with the most significant bit of the next word.

The last block 22 has a longer prefix to identify the end of the packed data. The prefix for block 22 consists of the 6-bit last block marker 100000, followed by 2 bits giving the number of words in the last block, 00 for one word, 01 for two words, 10 for 3 words and 11 for 4 words, followed by the normal block prefix. After this last block 22 is packed, any remaining bits in the last output word can be ignored. This last block prefix is not necessary if the number of input words is known to the decoder ahead of time.

In a worst case expansion of data over a large number of input words, all 16-bits are required to represent each block. In this case, the four 16-bit words 12 in each block 10 are placed, unchanged, into the output stream with an additional 0 bit representing no change from the previous block's packing width. Thus the worst-case expansion is one bit for every sixty-four bits. Other scenarios are possible giving the same expansion. For instance, blocks can alternate between 15-bit packing widths and 16-bit packing widths. In this case, every block has a 3-bit prefix representing a packing width delta of plus or minus one. Therefore, for every two input blocks there will be 3+4*15+3+4*16 bits=130 bits, which is again is one bit for every 64 bits expansion averaged over 2 blocks. The maximum expansion over the long run is always one bit for every 64 bits even though one of the blocks has a 3-bits for 64-bits expansion. Alternating between 13-bit and 16-bit packing widths, with 7-bit prefixes again results in 7+4*13+7+4*16 bits=130 bits over 2 blocks.

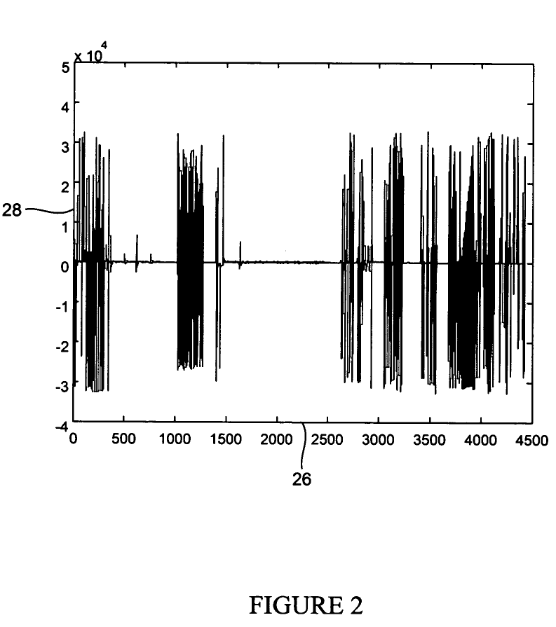

FIG. 2 is a graphical illustration of channel context memory contents for a typical voice over IP application. In this case the input signal is a noise signal encoded with pulse code modulation (PCM) that has been sampled at 8000 samples per second. There are 4428 16-bit words channel context memory contents, including taps from an echo canceller, that are graphed over time on axis 26. The words are graphed as two's complement numbers in 16-bit format from −32768 to 32767 on axis 28. The preferred compression algorithm may be applied to a processor containing numerous such channels to pack thousands of context memory data words into a smaller memory area, thereby significantly decreasing total die area and decreasing chip costs.

If the exemplary compression algorithm is used in a voice over Internet Protocol (VoIP) application, where available MIPs (Million Instructions Per Second) is not the limiting factor, this compression technique can increase the number of channels per processor chip. Available MIPs can be increased by increasing the clock rate, or adding more cores in a multi-core chip design. Even in situations where available MIPs is the limiting factor, this compression technique can be used to reduce the amount of on-chip memory required resulting in a smaller die size and accompanying lower cost per channel. A small power reduction will also result from a lower static power from the smaller memory.

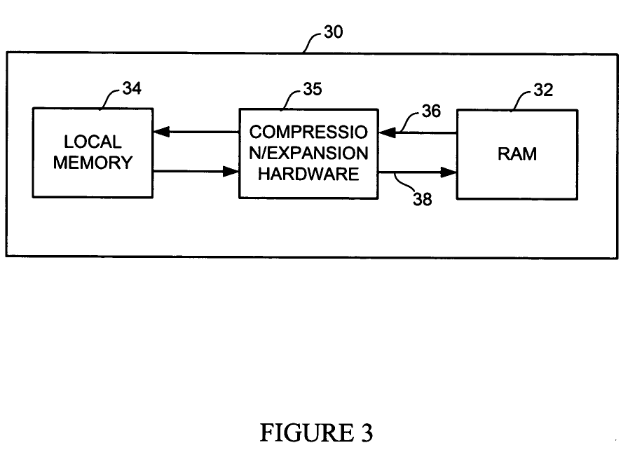

FIG. 3 is a functional illustration of data movement within processor 30 by the hardware engine between shared RAM (Random Access Memory) 32 and local memory 34. The compressed context for a channel would be expanded by hardware compression/expansion engine 35 and moved 36 from shared RAM 32 to local memory 34 prior to processing data in a channel. When processing for that channel is complete, the channel context would be compressed by hardware compression/expansion engine 35 and moved 38 from local memory 34 back into shared RAM 32. The compression algorithm allows for the design of a simple compression/expansion hardware engine, which compresses/expands data and moves it simultaneously. The hardware compression/expansion engine performs an expansion function with a source and destination address. When the expansion function is completed the channel is processed and then the engine also performs a compression function with a source and destination address. If compression is performed with a hardware engine, then most of the context will be processed. However, if compression is performed in software, the best tradeoff between MIPs and memory might be to process only those portions of the context that consistently compress well.

If an application contains constants or other data for each channel that does not change or rarely changes, then after that data is uncompressed in a write operation to local memory, it is not necessary for the hardware engine to re-compress and write the constant data back into shared memory.

As stated previously, the compressed contexts for all of the channels will be stored in some pool of shared memory. The size of each compressed context will vary, and the final size is not known until the compression actually occurs. A fixed-size buffer could be allocated ahead of time for each channel, but memory will be wasted if that buffer is too large. An additional data movement step is required, implemented either in hardware or software, for handling the spillover case, where a compressed context is larger than that fixed size. Alternatively, memory could be allocated from a global pool of smaller fixed size blocks that are chained together. In this solution, there must be a pointer word for every memory block. Larger block sizes will use fewer pointers, however this will result in more wasted memory in the last block of a compressed context. Another disadvantage of this method that the hardware compressor will have to be more complex to handle the chained block method. As a minimum, the hardware will have to handle the chaining of blocks as contexts are expanded or compressed. In addition, the hardware engine may require allocation techniques to allocate and free blocks of memory in realtime.

In the preferred exemplary embodiment, a combination of hardware and software is used to handle compressed contexts efficiently, but without too much hardware complexity. A global pool of fixed-size memory blocks is used. The Context Handler Engine is able to read from, and write to, pre-allocated chained blocks of memory but would not handle allocation and freeing of memory itself. Initially, each compressed context is stored in the minimum number of memory blocks necessary. When a channel number N−1 begins processing, software sets up the Context Handler Engine to expand the channel context for channel N from the pool storage into local memory 34. When channel N−1 finishes processing, the software increases the compressed context storage area for channel N−1 to a size large enough to handle the worst case by allocating new blocks. Software will then set up the Context Handler Engine to write out the compressed context for channel N−1. After the compression operation is complete, the Context Handler Engine will store the number of blocks actually used to write out this context. Meanwhile channel N will run and upon processing completion, the software will use the information in that register to free up any blocks of storage not used by the compressed context from channel N−1. Software then increases the compressed context storage area for channel N, and the cycle continues. With this method, there is always room to store any channels' context with no spillover problem and extra memory is only needed for one channel at a time.

If the memory required by all of the compressed contexts exceeds the amount that was anticipated, the processor implements an emergency graceful degradation algorithm to ensure all channels keep running. Reducing the length of an echo canceller's delay line rom 128 ms to 64 ms or reducing the length of a jitter buffer are examples from a voice over IP application where memory could be recovered in an emergency.

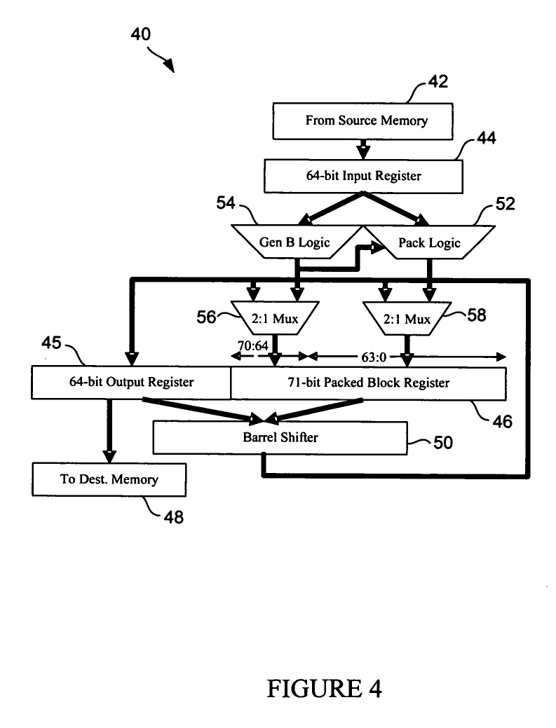

FIG. 4 illustrates a functional bock diagram of an exemplary hardware compression engine 40. The exemplary compression engine is assumed to be a 2-port device with a read port to access uncompressed words and a write port to write out compressed words. Words are read from source memory 42 into a 64-bit input register 44, four words at a time. Packed words are written out from a 64-bit output register (OR) 45. Four words are processed in parallel to speed up processing. However, where processing speed is not an issue, a lower complexity serial approach may be implemented. The exemplary compression algorithm is executed in eight steps, which could be pipelined so that four input words are processed each clock. There is a 64-bit Input Register (IR) 44, a 71-bit Packed Block Register (PBR) 46 and a 64-bit Output Register (OR) 45. N_{R}, the number of valid bits in the OR 45, is initialized to 0. B, the packing width of the previous block, is set to some default value.

In the encoder 40, four words are read from the source memory 42 into the 64-bit Input Register (IR) 44. The number of significant bits, B_{new}, in the largest-magnitude word is found. Delta B=B_{new}−B is computed, B is set to B_{new}, and the block prefix 20, with length L_{P}, is generated from delta B. The four words in the IR 44 are packed with the packing logic array 52 and Gen B Logic 54 and interleaved by multiplexers (Mux) 58 and 56 into the 4*B bits, bits 0:(4*B−1) of the PBR 46. The PBR 46 is then left shifted by 71−4*B−L_{P} bits. The block prefix 20 is placed into the L_{P} MSBs (Most Significant Bits) of the PBR 46. The new packed L_{P}+4*B bits in the PBR 46 can be as any as 71 bits. The OR 44 and the PBR 46, concatenated together in barrel shifter 50 as one 135-bit register, is shifted left by N₁=min(64−N_{R}, L_{P}+4*B) bits. N_{R} is then updated as N_{R}=N_{R}+N₁. If N_{R}=64, then the OR 44 is written out to four words in the destination memory 48 and the OR 45 and the PBR 46, concatenated together in barrel shifter 50 as one 135-bit register, is shifted left by N₂=min(64, L_{P}+4*B−N₁) bits. N_{R} is updated as N_{R}=N₂. If, once again N_{R}=64, the OR 45 is written out to four words in the destination memory 48 and the OR 45 and the PBR 46, concatenated together in barrel shifter 50 as one 135-bit register, is shifted left by N₃=L_{P}+4*B−N₁−N₂ bits. N_{R} is then updated as N_{R}=N₃.

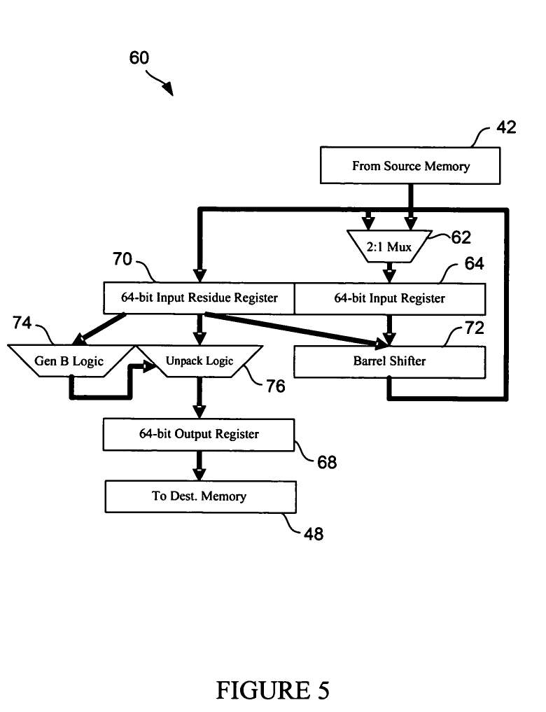

FIG. 5 illustrates an exemplary hardware expansion engine 60 used in the preferred embodiment. The exemplary expansion engine is a 2-port device with a read port to access compressed words and a write port to write out uncompressed words. Packed words are read from source memory 42 and interleaved through Mux 62 into a 64-bit input register 62, four words at a time. Unpacked words are written out from a 64-bit output register 68. Four words are processed in parallel to speed up processing. However, where processing speed is not an issue, a lower complexity serial approach may be implemented.

The exemplary algorithm executes decoder 60 in eight steps, which could be pipelined so that four output words are processed each clock. To start the processing, sixty-four bits are read from the source memory 42 into the 64-bit Input Residue Register (IRR) 70 and the next sixty-four bits are read from the source memory 42 and interleaved through 2:1 Mux 62 into the 64-bit Input Register (IR) 64. The number of valid bits in the IR 64, N₁, is set to sixty-four and B, the packing width of the previous block, is set to some default value. The next block prefix 20 is determined from the seven MSBs of the IRR 70 using the Gen B Logic 74. B is modified by delta B of the block prefix 20 to obtain the number of significant bits in the successive block and L_{P} is set to the length of the prefix. The IRR 70 and the IR 64, concatenated together as one 128-bit register in barrel shifter 72, are shifted left by N_{new}=max(N₁, L_{P}) bits. N₁ is then updated as N₁=N₁−Nnew. If N₁=0, then sixty-four bits are read from the source memory 42 into the IR 64, the IRR 70 and IR 64, concatenated together as one 128-bit register in barrel shifter 72, is shifted left by LP−N_{new} bits and N₁ is updated as N₁=64+N_{new}−L_{P}. The 4*B MSBs of the IRR 70 are unpacked by the unpacking logic array using Gen B Logic 74 and Unpack Logic 76 into the 64-bit Output Register (OR) 68. The 64-bit OR 68 is written out to four words in the destination memory 48. The IRR 70 and IR 64, concatenated together as one 128-bit register in barrel shifter 72, is next shifted left by N_{new}=max(N₁, 4*B) bits. N₁ is then updated N₁=N₁−N_{new}. If N₁=0, sixty four bits are read from the source memory 42 into the IR 64, the IRR 70 and IR 64, concatenated together as one 128-bit register in barrel shifter 72, is shifted left by 4*B−N_{new} bits and N₁ is then updated as N₁=64+N_{new}−4*B.

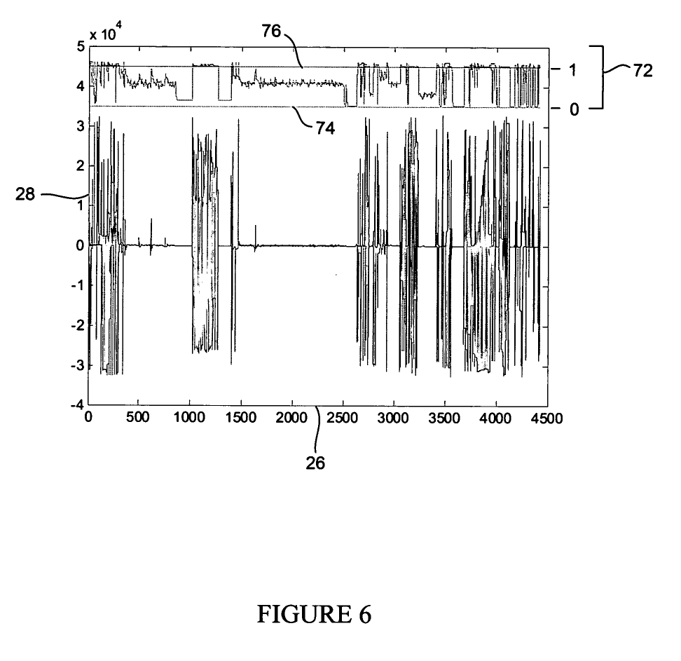

FIG. 6 illustrates the graph of FIG. 2 combined with a graph 72 of the compression ratio (e.g., packing lengths) for each of the blocks of four words. In graph 72, a zero compression line 74 is placed along the 35,000 mark of axis 28 and a one compression line 76 is placed along the 45,000 mark of axis 28. Graph 72 illustrates compressed bits divided by uncompressed bits and shows a comparison of compression to the uncompressed words of FIG. 2 along axis 26. Expansion of compressed data occurs where the graphed line in 72 rises above the one line 76. In graph 72, the 4428 words on axis 26 are compressed to 2796 words, a savings of 63%. As observed in FIG. 6, the regions from approximately 400 to 1000 and 1500 to 2500 compress very well. The regions from approximately 1000 to 1300 and 3700 to 4000 are examples of regions that do not compress well. However, most regions do provide compression and any expansion is minimal. Therefore, the more memory that is compressed by the exemplary algorithm, the more memory that is saved in the process.

Because many varying and different embodiments may be made within the scope of the inventive concept herein taught, and because many modifications may be made in the embodiments herein detailed in accordance with the descriptive requirements of the law, it is to be understood that the details herein are to be interpreted as illustrative and not in a limiting sense.

1. A method for reducing context memory requirements in a multi-tasking system, comprising:
providing a hardware engine in a computer processor,
applying a compression algorithm in said hardware engine to each instance in a multi-instance software system to reduce context memory in said software system.

2. The method of claim 1, wherein said applying comprises applying a generic, lossless compression algorithm that performs an adaptive packing operation.

3. The method of claim 1, wherein said applying comprises:
dividing data in instances of said multi-instance system into blocks; and
for each said instance:
assigning a packing width to a block having a maximum number of significant bits;
encoding, with said compression algorithm, least significant bits of each word in said block into a packed block of said packing width multiplied by a total number of words in said block; and
providing a prefix header at the beginning of each packed block to represent a change in said packing width from said packed block from a packing width of a previous packed block.

4. The method of claim 3, wherein said dividing comprises dividing blocks containing the same number of words.

5. The method of claim 3, wherein said providing said prefix header comprises encoding said prefix as a variable length sequence that uses between one and seven bits.

6. The method of claim 1, wherein said applying comprises encoding each word in a packed block using a lossless compression hardware engine integrated into said processor.

7. The method of claim 3, wherein said encoding comprises performing an adaptive packing operation on said least significant bits.

8. The method of claim 3, further comprising:
expanding said compressed data with a decoder on said hardware engine; and
moving said expanded data from a shared memory on said processor to a local memory on said processor;
processing said data in said channel in accordance with the application running on said processor; and
moving said compressed data from said local memory into said shared memory.

9. The method of claim 3, further comprising:
providing a last block prefix header to a final block of said data, wherein said last block prefix header comprises a last block marker of six bits followed by two bits that define the number of said words contained in the final block.

10. A method for reducing context memory requirements in a multi-tasking system, comprising:
providing a hardware engine in a computer processor,
dividing data in a task of said multi-tasking system into blocks of words;
applying a compression algorithm in said hardware engine to each word to create packed blocks of said words; and
providing a prefix header at the beginning of each packed block to represent a change in packing width from said packed block from a packing width of a previous packed block.

11. The method of claim 10, wherein each block contains the same number of said words.

12. The method of claim 10, further comprising for each said task:
determining a word in a block having a maximum number of significant bits;
assigning a packing width to said block of said maximum number of significant bits;
encoding, with said compression algorithm, least significant bits of each word in said block into a packed block of said packing width multiplied by a total number of words in said block.

13. The method of claim 10, wherein said compression algorithm is lossless compression algorithm.

14. The method of claim 10, further comprising:
expanding said compressed data with a decoder on said hardware engine; and
moving said expanded data from a shared memory on said processor to a local memory on said processor;
processing said data in said channel in accordance with the application running on said processor; and
moving said compressed data from said local memory into said shared memory.

15. The method of claim 10, further comprising:
providing a last block prefix header to a final block of said data, wherein said last block prefix header comprises a last block marker of six bits followed by two bits that define the number of said words contained in the final block.
